(19) United States
(12) Patent Application Publication
(10) Pub. No.: US 2014/0085588 A1
(43) Pub. Date: Mar. 27, 2014

(54) Mixture for Liquid Crystal Medium and Liquid Crystal Display Using the Same

(71) Applicants: Xing Feng, Shenzhen City (CN); Yubo Gu, Shenzhen City (CN); Liuyang Yang, Shenzhen City (CN); Xinhui Zhong, Shenzhen City (CN)

(72) Inventors: Xing Feng, Shenzhen City (CN); Yubo Gu, Shenzhen City (CN); Liuyang Yang, Shenzhen City (CN); Xinhui Zhong, Shenzhen City (CN)

(73) Assignee: Shenzhen China Star Optoelectronics Technology Co. Ltd., Shenzhen, Guangdong (CN)

(21) Appl. No.: 13/703,429

(22) PCT Filed: Oct. 16, 2012
(86) PCT No.: PCT/CN2012/082992

§ 371 Date: Dec. 11, 2012

(30) Foreign Application Priority Data
Sep. 21, 2012 (CN) 201210355423.6

(51) Int. Cl. C09K 19/30; G02F 1/1333

(52) U.S. Cl. CPC C09K 19/3098; G02F 1/1333
USPC 349/158; 252/299.63

(57) ABSTRACT

The present invention provides a mixture for liquid crystal medium and a liquid crystal display using the same. The mixture for liquid crystal medium comprises: a liquid crystal material and a polymerizable monomer. The liquid crystal material comprises an alkenyl compound which is stable to the polymerization reaction during the polymerization of the polymerizable monomer. The polymerizable monomer comprises two or more monomers, wherein it comprises at least one fast reaction type of monomer and at least one strong anchoring force type of monomer. The liquid crystal display comprises: an upper substrate and a lower substrate which are parallel with each other, and a mixture for liquid crystal medium provided between the upper substrate and the lower substrate. In the mixture for liquid crystal medium and a liquid crystal display using the same according to the present invention, by using two or more polymerizable monomer with different functions, the reaction rate of the polymerization reaction, the uniformity of the generated polymer, and the strength of the anchoring force can be balanced at the same time and reach a higher level, which improves the optical properties and overall performance of the panel and the stable mass production.

This application claims priority to Chinese Patent Application Serial No. 201210355423.6, named as “mixture for liquid crystal medium and liquid crystal display using the same”, filed on Sep. 21, 2012, the specification of which is incorporated herein by reference.

### BACKGROUND OF THE INVENTION

1. Field of the Invention

The present invention relates to the field of liquid crystal display technology, and in particular to a mixture for liquid crystal medium and a liquid crystal display using the same.

2. The Related Arts

The liquid crystal used for twisted nematic (TN) or super twisted nematic (STN) liquid crystal display is positive-type liquid crystal. The long axis of the liquid crystal molecules is parallel to the surface of the substrate when the power is off. The alignment direction of the liquid crystal molecules on the surface of the substrate depends on the rubbing direction of alignment layer, which material usually is polyimide. The alignment directions of the surface of both substrates are perpendicular to each other. Hence, the molecules within the liquid crystal layer maintain in continuous twisted alignment state from the surface of one substrate to the surface of the other substrate. After the voltage is applied, the long axis of the liquid crystal molecules will tend to be aligned along the direction of the electric field. The drawback of the TN/STN type liquid crystal display is that it has small viewing angle, brightness difference and significant chromatic aberration under large viewing angle, which needs to be improved by the compensation film and thereby increases the manufacturing cost of the display.

Multi-domain vertical alignment (MVA) TFT-LCD using negative type liquid crystal and vertically aligned film material has solved the restrictions of the viewing angle of TN/STN display. When no voltage is applied, the long axis of the liquid crystal molecules is perpendicular to the surface of the substrate. When the voltage is applied, the liquid crystal molecules will topple down and the long axis of the liquid crystal molecules will tend to be aligned along the vertical direction of the electric field. In order to solve the problems of the viewing angle, a sub-pixel is divided into multiple regions, so that the liquid crystal molecules can topple down in different direction, which makes the views of the display seen in different directions tend to be the same. There are several ways to allow the liquid crystal molecules in the different regions to be oriented in different directions in one sub-pixel. The first one is to build a bump at the upper and lower substrates of the LCD by exposure and development, so that the liquid crystal molecules around the bump can produce a certain pre-inclined angle and topple down toward the fixed direction. The second one is to form predetermined pattern of indium tin oxide (ITO) pixel electrodes at the upper and lower substrates, which will generate an electric field with a certain inclined angle to control the toppling direction of the liquid crystal molecules in the different regions. This is called as patterned vertical alignment (PVA) technology. The third one is to form ITO slits at the TFT side of the LCD substrate and full ITO at the other side. And then add the polymerizable monomer into the liquid crystal medium. First, make the liquid crystal molecules topple down by an electric field, at the same time, irradiate the monomer with ultraviolet light to polymerize and form the polymer particles which can guide the toppling direction of the liquid crystal molecules. The polymer particles deposited on the surface of the substrate play the role of the alignment. This is called as polymer stabilized vertical alignment (PSVA).

The reaction rate of the polymerizable monomer, the size and the distribution of the polymer, the surface uniformity of the substrate, and the strength of the anchoring force have major impacts on the optical properties of the panel and the stability of the production. In addition to the process conditions, these factors are mainly dependent on the molecular structure of the polymerizable monomer which directly determines the speed of the light reaction, the characteristics of the polymer and the strength of the anchoring force to the liquid crystal. Because the conventional liquid crystal medium comprises alkenyl compound, it is beneficial to obtain a low rotational viscosity to improve the response of liquid crystal medium. The alkenyl compound within the liquid crystal medium will affect the polymerization reaction of the polymerizable monomer easily and then the alignment of the liquid crystal medium. Hence, in general, single polymerizable monomer is very difficult to make the factors mentioned above in a favorable situation. The actual situation often attends to one thing and loses track of another, such as good uniformity of the polymer accompanied with low anchoring force, or strong anchoring force accompanied with slow reaction rate and so on.

### SUMMARY OF THE INVENTION

The technical issue to be solved by the present invention is to provide a mixture for liquid crystal medium, wherein by using two or more a polymerizable monomer with different functions, the reaction rate of the polymerization reaction, the uniformity of the generated polymer and the strength of the anchoring force can be balanced at the same time and reach a higher level.

The present invention further provides a liquid crystal display comprising the mixture for liquid crystal medium, wherein by using two or more polymerizable monomer with different functions, the reaction rate of the polymerization reaction of the monomer, the uniformity of the generated polymer and the strength of the anchoring force can be balanced at the same time and reach a higher level, which improves the optical properties and overall performance of the panel and the stable mass production.

In order to solve the technical issue, the embodiment according to the present invention provides a mixture for liquid crystal medium comprising: a liquid crystal material and a polymerizable monomer, the liquid crystal material comprising an alkenyl compound which is stable to the polymerization reaction during the polymerization of the polymerizable monomer, the polymerizable monomer comprising two or more monomers, wherein it comprises at least one fast reaction type of monomer and at least one strong anchoring force type of monomer;
the fast reaction type of monomer defined by the following structural formula I:

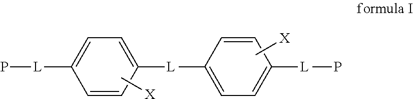

wherein, P represents a polymerizable group, and each them are the same or different, which is selected from the group consisting of methacrylate group, acrylate group, vinyl group, ethylene group or epoxy group; L represents linking group, and each them are the same or different, which is selected from the group consisting of single bond, —O—, —COO—, —OCO—, —CH₂O—, —OCH₂O—, —O(CH₂)₂O—, —COCH₂— or methylene; x represents the substituent group, which is selected from the group consisting of P, L, or other substituent group;
the strong anchoring force type of monomer defined by the following structural formula II:

P₁-L₁-X-L₂-M formula II

wherein, P₁ represents a polymerizable group, which is selected from the group consisting of methacrylate group, acrylate group, vinyl group, ethylene group or epoxy group; L₁ and L₂ represent linking groups, and each them are the same or different, which are selected from the group consisting of single bond, —O—, —COO—, —OCO—, —CH₂O—, —OCH₂O—, —O(CH₂)₂O—, —COCH₂— or methylene; X represents a core group, which is composed of two benzene rings directly or indirectly connected with each other or two benzene rings and a cyclohexane directly or indirectly connected with each other; M represents a straight chain or branched chain alkyl containing number of carbon atoms from 1 to 7, or a structural group containing polymerizable group P₁;
wherein, all the polymerizable groups in the formula I and formula II are not methacrylate group simultaneously.

Wherein, the alkenyl compound is defined by the following structural formulas:

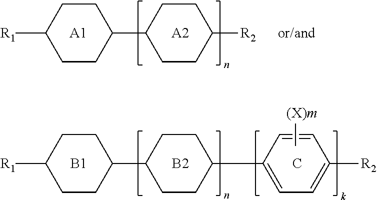

wherein,

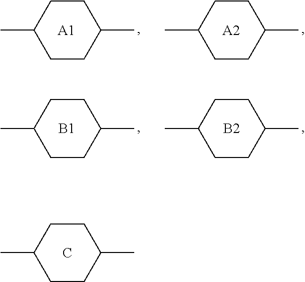

independently represents:

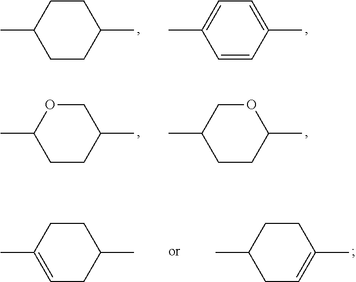

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

Wherein, the X in the formula II is selected from the group consisting of:

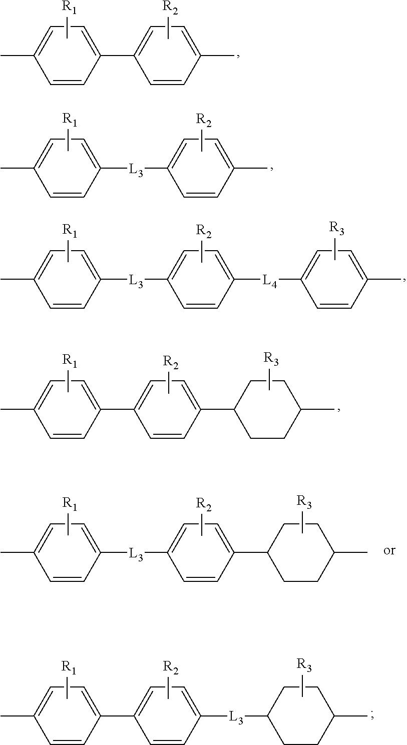

wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

Wherein, the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.

Another embodiment according to the present invention further provides a liquid crystal display comprising: a upper substrate and a lower substrate which are parallel with each other, and a mixture for liquid crystal medium provided between the upper substrate and the lower substrate, the mixture for liquid crystal medium comprising: a liquid crystal material and a polymerizable monomer, the liquid crystal material comprising an alkenyl compound which is stable to the polymerization reaction during the polymerization of the polymerizable monomer, the polymerizable monomer comprising two or more monomers, wherein it comprises at least one fast reaction type of monomer and at least one strong anchoring force type of monomer;
the fast reaction type of monomer defined by the following structural formula I:

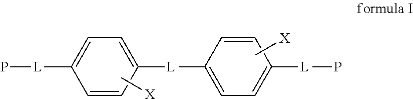

wherein, P represents a polymerizable group, and each them are the same or different, which is selected from the group consisting of methacrylate group, acrylate group, vinyl group, ethylene group or epoxy group; L represents linking group, and each them are the same or different, which is selected from the group consisting of single bond, —O—, —COO—, —OCO—, —CH₂O—, —OCH₂O—, —O(CH₂)₂O—, —COCH₂— or methylene; x represents the substituent group, which is selected from the group consisting of P, L, or other substituent group;
the strong anchoring force type of monomer defined by the following structural formula II:

P₁-L₁-X-L₂-M formula II

wherein, P₁ represents a polymerizable group, which is selected from the group consisting of methacrylate group, acrylate group, vinyl group, ethylene group or epoxy group; L₁ and L₂ represent linking groups, and each them are the same or different, which are selected from the group consisting of single bond, —O—, —COO—, —OCO—, —CH₂O—, —OCH₂O—, —O(CH₂)₂O—, —COCH₂— or methylene; X represents a core group, which is composed of two benzene rings directly or indirectly connected with each other or two benzene rings and a cyclohexane directly or indirectly connected with each other; M represents a straight chain or branched chain alkyl containing number of carbon atoms from 1 to 7, or a structural group containing polymerizable group P₁;
wherein, all the polymerizable groups in the formula I and formula II are not methacrylate group simultaneously.

Wherein, the alkenyl compound is defined by the following structural formulas:

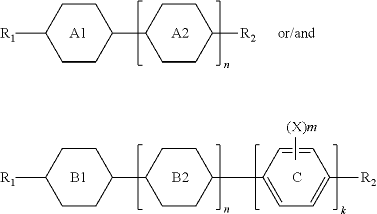

wherein,

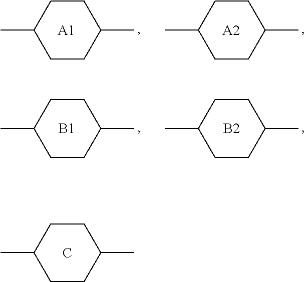

independently represents:

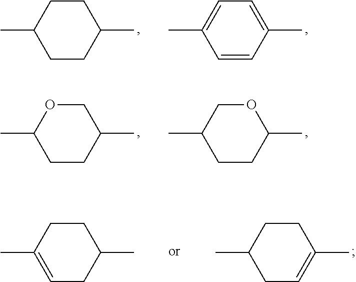

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

Wherein, the X in the formula II is selected from the group consisting of:

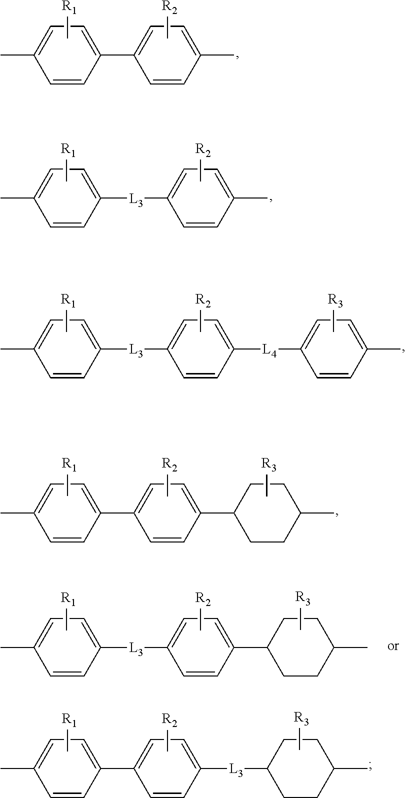

wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

Wherein, the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.

The embodiment according to the present invention has the beneficial effects as follow:
the mixture for liquid crystal medium according to the present invention, by using two or more polymerizable monomer with different functions, the reaction rate of the polymerization reaction, the uniformity of the generated polymer and the strength of the anchoring force can be balanced at the same time and reach a higher level. It improves the optical properties and overall performance of the panel and the stable mass production when applied in the liquid crystal display.

### DETAILED DESCRIPTION OF THE PREFERRED EMBODIMENTS

The mixture for liquid crystal medium according to the present invention comprises: a liquid crystal material and a polymerizable monomer. The liquid crystal material comprises an alkenyl compound which is stable to the polymerization reaction during the polymerization of the polymerizable monomer. The polymerizable monomer comprises two or more monomers, wherein it comprises at least one fast reaction type of monomer and at least one strong anchoring force type of monomer. By using two or more a polymerizable monomer with different functions, the reaction rate of the polymerization reaction, the uniformity of the generated polymer and the strength of the anchoring force can be balanced at the same time and reach a higher level. That is, while the reaction rate is quick, the uniformity of the generated polymer and the strength of the anchoring force are also high. The weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100, which the better is 10:100 to 10:50.

Wherein, the fast reaction type of monomer is defined by the following structural formula I:

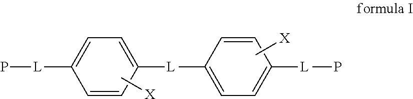

wherein, P represents a polymerizable group, and each them are the same or different, which is selected from the group consisting of methacrylate group, acrylate group, vinyl group, ethylene group or epoxy group; L represents linking group, and each them are the same or different, which is selected from the group consisting of single bond, —O—, —COO—, —OCO—, —CH₂O—, —OCH₂O—, —O(CH₂)₂O—, —COCH₂— or methylene; x represents the substituent group, which is selected from the group consisting of P, L, or other substituent group;
the strong anchoring force type of monomer is defined by the following structural formula II:

P₁-L₁-X-L₂-M formula II

wherein, P₁ represents a polymerizable group, which is selected from the group consisting of methacrylate group, acrylate group, vinyl group, ethylene group or epoxy group; L₁ and L₂ represent linking groups, and each them are the same or different, which are selected from the group consisting of single bond, —O—, —COO—, —OCO—, —CH₂O—, —OCH₂O—, —O(CH₂)₂O—, —COCH₂— or methylene; X represents a core group, which is composed of two benzene rings directly or indirectly connected with each other or two benzene rings and a cyclohexane directly or indirectly connected with each other; M represents a straight chain or branched chain alkyl containing number of carbon atoms from 1 to 7, or a structural group containing polymerizable group P₁;
wherein, all the polymerizable groups in the formula I and formula II are not methacrylate group simultaneously.

The X in the formula II is selected from the group consisting of:

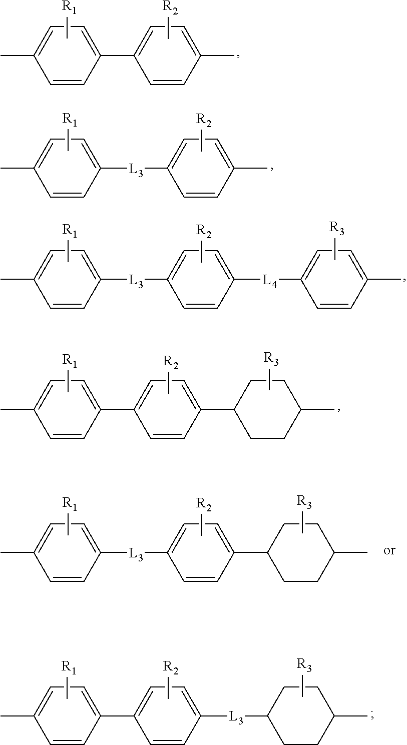

wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

The alkenyl compound is defined by the following structural formulas:

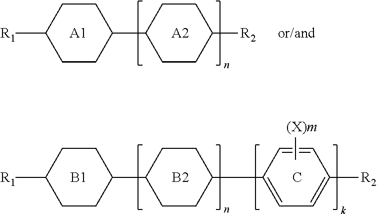

wherein,

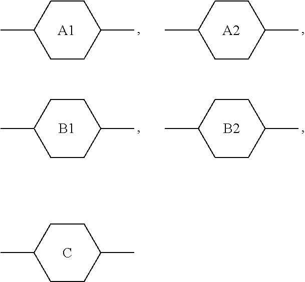

independently represents:

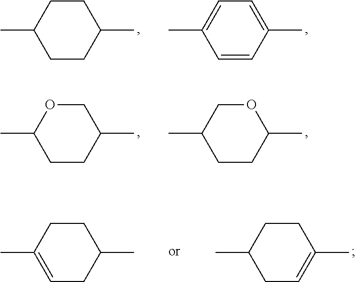

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

The liquid crystal material is preferably a negative-type liquid crystal material.

The mixture for liquid crystal medium according to the present invention can be applied in display. The liquid crystal display according to the present invention uses the mixture for liquid crystal medium mentioned above, which comprises a upper substrate and a lower substrate which are parallel with each other, and a mixture for liquid crystal medium provided between the upper substrate and the lower substrate. The mixture for liquid crystal medium comprises: a liquid crystal material and a polymerizable monomer. The polymerizable monomer comprises two or more monomers, wherein it comprises at least one fast reaction type of monomer and at least one strong anchoring force type of monomer. The mixture for liquid crystal medium is the mixture for liquid crystal medium according to the present invention mentioned above and not be repeated here. By using two or more polymerizable monomer with different functions, the reaction rate of the polymerization reaction of the monomer, the uniformity of the generated polymer and the strength of the anchoring force can be balanced at the same time and reach a higher level. That is, while the reaction rate is quick, the uniformity of the generated polymer and the strength of the anchoring force are also high, which improves the optical properties and overall performance of the panel and the stable mass production.

The embodiment according to the present invention uses a monomer and a dimer to be described as follows. Wherein, Δn is optical anisotropy of the liquid crystal material, Ac is dielectric anisotropy of the liquid crystal material, and Tni is clearing point temperature of the liquid crystal material.

### Embodiment 1

Choose a negative-type liquid crystal material, which Tni is 75° C., Δn is 0.095 (25° C., 589 nm), and Δε is −2.8 (25° C., 1 kHz). A certain amounts of the fast reaction type of monomer and the strong anchoring force type of monomer according to the present invention are mixed with the liquid crystal material to obtain the desired mixture for liquid crystal medium. The molar ratio of the fast reaction type of monomer to the strong anchoring force type of monomer is 10:50, and the total weight percentage of both accounts for 0.35% of the liquid crystal material. Wherein, the structural formula of the fast reaction type of monomer is as follows:

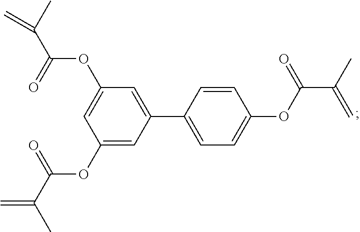 [SMILES: C=C(C)C(=O)Oc1ccc(-c2cc(OC(=O)C(=C)C)cc(OC(=O)C(=C)C)c2)cc1]

the structural formula of the strong anchoring force type of monomer is as follows:

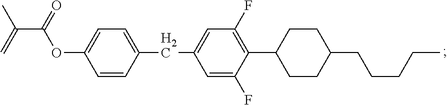 [SMILES: C=C(C)C(=O)Oc1ccc(Cc2cc(F)c(C3CCC(CCCCC)CC3)c(F)c2)cc1]

The mixture for liquid crystal medium is dropped on the prepared TFT array substrate by one drop filling (ODF), which is assembled with CF substrate. After pre-curing the sealant, use UV light to irradiate the panel while applying AC square wave voltage of 15V and 60 Hz to the panel, which allows the polymerizable monomer in the mixture for liquid crystal medium occurring copolymerization reaction. The formed polymer bump has small and uniform size, and the light spots won't occur at the dark state. And then complete the alignment.

### Embodiment 2

Choose a negative-type liquid crystal material, which Tni is 75° C., Δn is 0.095 (25° C., 589 nm), and Δε is −2.8 (25° C., 1 kHz). A certain amounts of the fast reaction type of monomer and the strong anchoring force type of monomer according to the present invention are mixed with the liquid crystal material to obtain the desired mixture for liquid crystal medium. The molar ratio of the fast reaction type of monomer to the strong anchoring force type of monomer is 10:1, and the total weight percentage of both accounts for 0.05% of the liquid crystal material. Wherein, the structural formula of the fast reaction type of monomer is as follows:

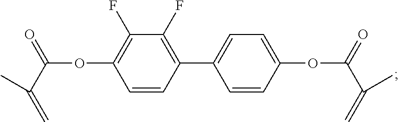 [SMILES: C=C(C)C(=O)Oc1ccc(-c2ccc(OC(=O)C(=C)C)c(F)c2F)cc1]

the structural formula of the strong anchoring force type of monomer is as follows:

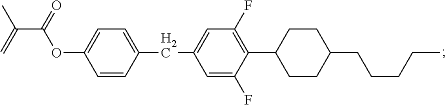 [SMILES: C=C(C)C(=O)Oc1ccc(Cc2cc(F)c(C3CCC(CCCCC)CC3)c(F)c2)cc1]

The mixture for liquid crystal medium is dropped on the prepared TFT array substrate by one drop filling (ODF), which is assembled with CF substrate. After pre-curing the sealant, use UV light to irradiate the panel while applying AC square wave voltage of 15V and 60 Hz to the panel, which allows the polymerizable monomer in the mixture for liquid crystal medium occurring copolymerization reaction. The formed polymer bump has small and uniform size, and the light spots won't occur at the dark state. And then complete the alignment.

### Embodiment 3

Choose a negative-type liquid crystal material, which Tni is 75° C., Δn is 0.095 (25° C., 589 nm), and Δε is −2.8 (25° C., 1 kHz). A certain amounts of the fast reaction type of monomer and the strong anchoring force type of monomer according to the present invention are mixed with the liquid crystal material to obtain the desired mixture for liquid crystal medium. The molar ratio of the fast reaction type of monomer to the strong anchoring force type of monomer is 10:100, and the total weight percentage of both accounts for 0.5% of the liquid crystal material. Wherein, the structural formula of the fast reaction type of monomer is as follows:

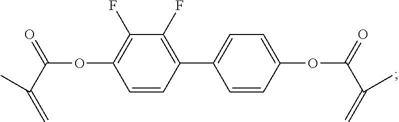 [SMILES: C=C(C)C(=O)Oc1ccc(-c2ccc(OC(=O)C(=C)C)c(F)c2F)cc1]

the structural formula of the strong anchoring force type of monomer is as follows:

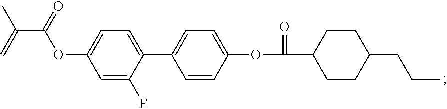 [SMILES: C=C(C)C(=O)Oc1ccc(-c2ccc(OC(=O)C3CCC(CCC)CC3)cc2)c(F)c1]

The mixture for liquid crystal medium is dropped on the prepared TFT array substrate by one drop filling (ODF), which is assembled with CF substrate. After pre-curing the sealant, use UV light to irradiate the panel while applying AC square wave voltage of 15V and 60 Hz to the panel, which allows the polymerizable monomer in the mixture for liquid crystal medium occurring copolymerization reaction. The formed polymer bump has small and uniform size, and the light spots won't occur at the dark state. And then complete the alignment.

### Embodiment 4

Choose a negative-type liquid crystal material, which Tni is 75° C., Δn is 0.095 (25° C., 589 nm), and Δε is −2.8 (25° C., 1 kHz). A certain amounts of the fast reaction type of monomer and two strong anchoring force type of monomer according to the present invention are mixed with the liquid crystal material to obtain the desired mixture for liquid crystal medium. The molar ratio of the fast reaction type of monomer to the strong anchoring force type of monomer is 10:50, and the total weight percentage of both accounts for 0.35% of the liquid crystal material. Wherein, the structural formula of the fast reaction type of monomer is as follows:

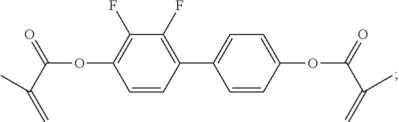 [SMILES: C=C(C)C(=O)Oc1ccc(-c2ccc(OC(=O)C(=C)C)c(F)c2F)cc1]

the structural formulas of the two strong anchoring force type of monomers are as follows:

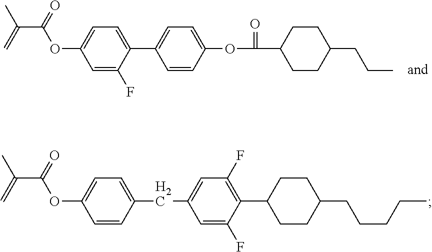

wherein, the two strong anchoring force type monomers have the same content.
The mixture for liquid crystal medium is dropped on the prepared TFT array substrate by one drop filling (ODF), which is assembled with CF substrate. After pre-curing the sealant, use UV light to irradiate the panel while applying AC square wave voltage of 15V and 60 Hz to the panel, which allows the polymerizable monomer in the mixture for liquid crystal medium occurring copolymerization reaction. The formed polymer bump has small and uniform size, and the light spots won't occur at the dark state. And then complete the alignment.

In summary, the mixture for liquid crystal medium used for liquid crystal display according to the present invention, by using two or more a polymerizable monomer with different functions, the reaction rate of the polymerization reaction, the uniformity of the generated polymer and the strength of the anchoring force can be balanced at the same time and reach a higher level. It improves the optical properties and overall performance of the panel and the stable mass production when applied in the liquid crystal display.

The preferred embodiments according to the present invention are mentioned above, which cannot be used to define the scope of the right of the present invention. Those modifications and variations are considered encompassed in the scope of protection defined by the claims of the present invention.

What is claimed is:

1. A mixture for liquid crystal medium comprising: a liquid crystal material and a polymerizable monomer, the liquid crystal material comprising an alkenyl compound which is stable to the polymerization reaction during the polymerization of the polymerizable monomer, the polymerizable monomer comprising two or more monomers, wherein it comprises at least one fast reaction type of monomer and at least one strong anchoring force type of monomer;
the fast reaction type of monomer defined by the following structural formula: 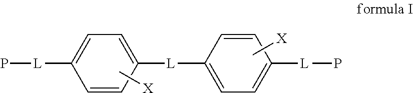
wherein, P represents a polymerizable group, and each them are the same or different, which is selected from the group consisting of methacrylate group, acrylate group, vinyl group, ethylene group or epoxy group; L represents linking group, and each them are the same or different, which is selected from the group consisting of single bond, —O—, —COO—, —OCO—, —CH₂O—, —OCH₂O—, —O(CH₂)₂O—, —COCH₂— or methylene; x represents the substituent group, which is selected from the group consisting of P, L, or other substituent group;
the strong anchoring force type of monomer defined by the following structural formula:
P₁-L₁-X-L₂-M formula II
wherein, P₁ represents a polymerizable group, which is selected from the group consisting of methacrylate group, acrylate group, vinyl group, ethylene group or epoxy group; L₁ and L₂ represent linking groups, and each them are the same or different, which are selected from the group consisting of single bond, —O—, —COO—, —OCO—, —CH₂O—, —OCH₂O—, —O(CH₂)₂O—, —COCH₂— or methylene; X represents a core group, which is composed of two benzene rings directly or indirectly connected with each other or two benzene rings and a cyclohexane directly or indirectly connected with each other; M represents a straight chain or branched chain alkyl containing number of carbon atoms from 1 to 7, or a structural group containing polymerizable group P1;
wherein, all the polymerizable groups in the formula I and formula II are not methacrylate group simultaneously.

2. The mixture for liquid crystal medium as claimed in claim 1, characterized in that the alkenyl compound is defined by the following structural formulas: 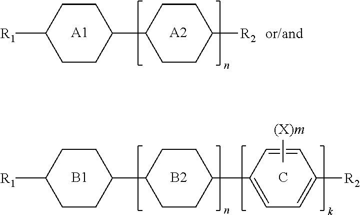
wherein, 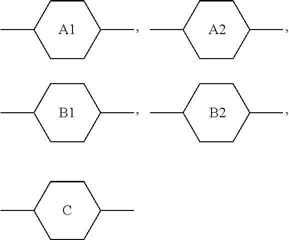
independently represents: 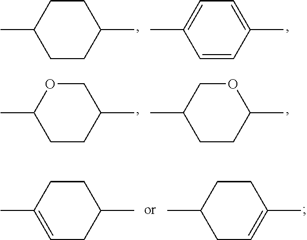
R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

3. The mixture for liquid crystal medium as claimed in claim 1, characterized in that the X in the formula II is selected from the group consisting of: 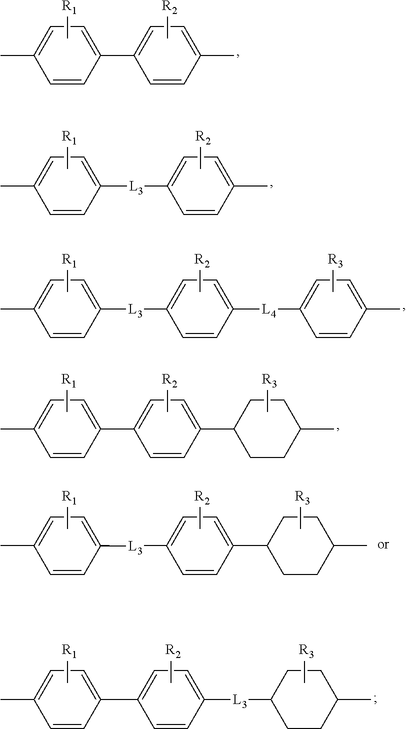
wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

4. The mixture for liquid crystal medium as claimed in claim 3, characterized in that the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.

5. The mixture for liquid crystal medium as claimed in claim 2, characterized in that the X in the formula II is selected from the group consisting of: 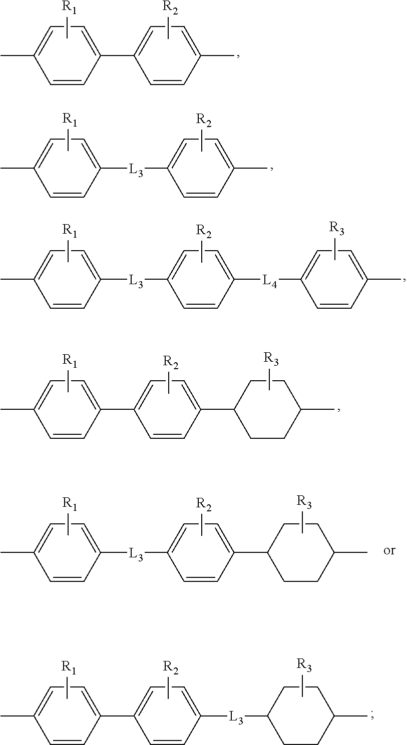
wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

6. The mixture for liquid crystal medium as claimed in claim 5, characterized in that the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.

7. A liquid crystal display comprising: a upper substrate and a lower substrate which are parallel with each other, and a mixture for liquid crystal medium provided between the upper substrate and the lower substrate, the mixture for liquid crystal medium comprising: a liquid crystal material and a polymerizable monomer, the liquid crystal material comprising an alkenyl compound which is stable to the polymerization reaction during the polymerization of the polymerizable monomer, the polymerizable monomer comprising two or more monomers, wherein it comprises at least one fast reaction type of monomer and at least one strong anchoring force type of monomer;
the fast reaction type of monomer defined by the following structural formula: 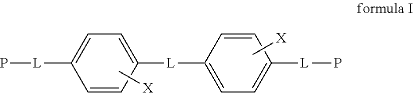
wherein, P represents a polymerizable group, and each them are the same or different, which is selected from the group consisting of methacrylate group, acrylate group, vinyl group, ethylene group or epoxy group; L represents linking group, and each them are the same or different, which is selected from the group consisting of single bond, —O—, —COO—, —OCO—, —CH₂O—, —OCH₂O—, —O(CH₂)₂O—, —COCH₂— or methylene; x represents the substituent group, which is selected from the group consisting of P, L, or other substituent group;
the strong anchoring force type of monomer defined by the following structural formula:
P₁-L₁-X-L₂-M formula II
wherein, P₁ represents a polymerizable group, which is selected from the group consisting of methacrylate group, acrylate group, vinyl group, ethylene group or epoxy group; L₁ and L₂ represent linking groups, and each them are the same or different, which are selected from the group consisting of single bond, —O—, —COO—, —OCO—, —CH₂O—, —OCH₂O—, —O(CH₂)₂O—, —COCH₂— or methylene; X represents a core group, which is composed of two benzene rings directly or indirectly connected with each other or two benzene rings and a cyclohexane directly or indirectly connected with each other; M represents a straight chain or branched chain alkyl containing number of carbon atoms from 1 to 7, or a structural group containing polymerizable group P1;
wherein, all the polymerizable groups in the formula I and formula II are not methacrylate group simultaneously.

8. The liquid crystal display as claimed in claim 7, characterized in that the alkenyl compound is defined by the following structural formulas: 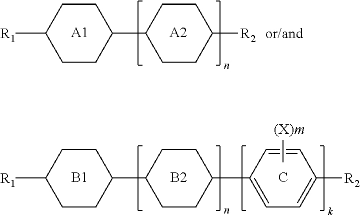
wherein, 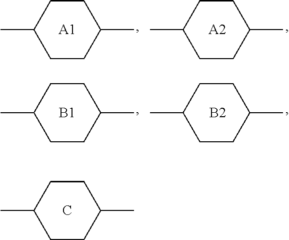
independently represents: 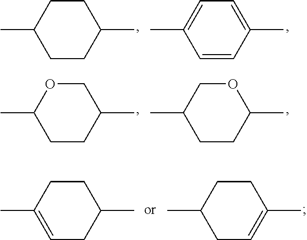
R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

9. The liquid crystal display as claimed in claim 7, characterized in that the X in the formula II is selected from the group consisting of: 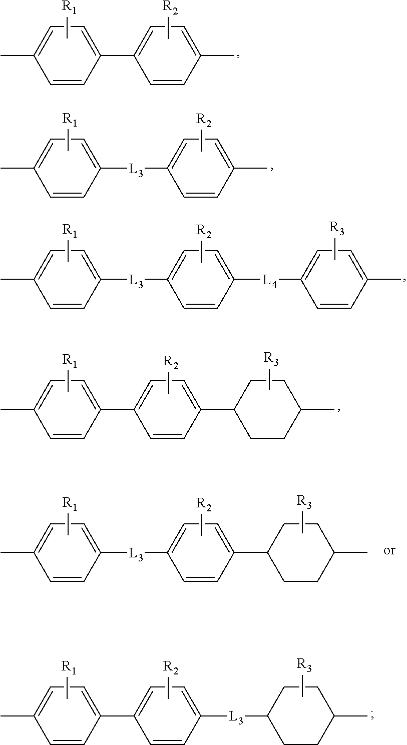
wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

10. The liquid crystal display as claimed in claim 9, characterized in that the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.

11. The liquid crystal display as claimed in claim 8, characterized in that the X in the formula II is selected from the group consisting of: 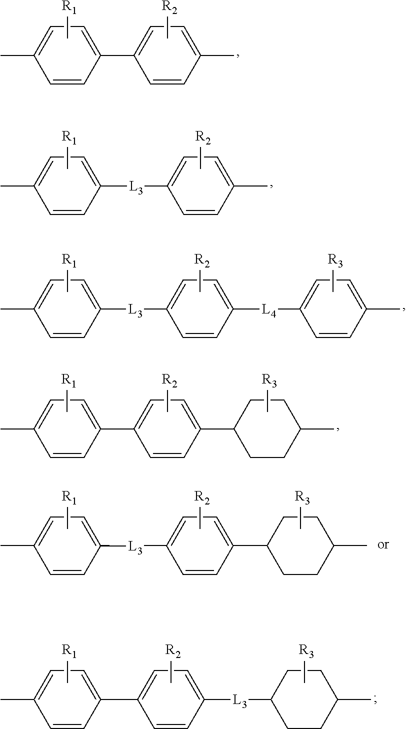
wherein, each R₁, R₂, and R₃ are the same or different, which are selected from the group consisting of H, F, Cl, Br, CN, methyl or ethyl; each L₃ and L₄ are the same or different, which are selected from the group consisting of single bond, —O—, —COO—, —OCO—, —CH₂O—, —OCH₂O—, —O(CH₂)₂O—, —COCH₂— or methylene.

12. The liquid crystal display as claimed in claim 11, characterized in that the weight percentage of the polymerizable monomer accounts for 0.05% to 0.5% of the mixture for liquid crystal medium, and the molar ratio of the fast reaction type of monomer to the strong anchoring force type of monomer in the mixture for liquid crystal medium is 10:1 to 10:100.
